(19) United States
(12) Patent Application Publication
(10) Pub. No.: US 2008/0025544 A1
(43) Pub. Date: Jan. 31, 2008

(54) Portable cooler and audio console

(75) Inventor: John Maldonado, Katy, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Igloo Products Corp., Katy, TX (US)

(21) Appl. No.: 11/881,927

(22) Filed: Jul. 30, 2007

Related U.S. Application Data
(60) Provisional application No. 60/834,122, filed on Jul. 28, 2006.

(51) Int. Cl. H04R 1/02

(52) U.S. Cl. 381/334

(57) ABSTRACT

A cooler and digital audio console combines the benefits of a digital audio player and a cooler in one container. The cooler and digital audio console includes a cooler body having an interior cooler body, insulation surrounding the cooler body, and an exterior layer surrounding the insulation. The cooler includes a lid that has a removable and adjustable audio console housing. The audio console housing includes one or more speakers and a control panel for providing power and control features for the audio feed being emitted by a digital audio player. The audio console housing also includes a integration device, such as a docking port or headphone jack for connecting a digital audio player to the audio console housing. The audio console housing can be adjusted to different angles to direct the speakers towards the listening audience, or being removed from the cooler and positioned closer to the audience.

### STATEMENT OF RELATED PATENT APPLICATION

This non-provisional patent application claims priority under 35 U.S.C. §119 to U.S. Provisional Patent Application No. 60/834,122, titled Cooler and Digital Music Console, filed Jul. 28, 2006. This provisional application is hereby fully incorporated herein by reference.

### FIELD OF THE INVENTION

This invention relates generally to the field of insulated containers such as coolers or ice chests. More particularly, the present invention relates to a combination cooler and audio console apparatus.

### BACKGROUND OF THE INVENTION

As the popularity of coolers and ice chests has grown, additional features have been added to enhance their convenience. Some conventional coolers include radios that are permanently affixed to the cooler body. Such conventional cooler/radio combinations have several drawbacks. In general the conventional combinations provided the listening audience with a limited ability to select the music that they wanted to hear, through the use of channel selection. In addition, since the radios were dependent on their ability to receive a signal through an antenna, the user of the cooler was limited in the places where the cooler could provide an adequate radio feed.

While other conventional cooler combinations also included a cassette player or compact disc player with the radio, these combinations became overly bulky and took up too much of the cooler capacity to maintain their portability. In addition, the user was still limited in their music selection to what was on the tapes or compact discs. Furthermore, the speakers and radios in the conventional combinations were typically in a fixed position on the cooler and could not be adjusted or removed. This prevented the listening audience from adjusting the angle of the speakers to direct the audio output towards the listening audience. In addition, a user was not able to remove the playing apparatus from the cooler and move it to a separate location that was more desirable to the user while still having the capability to function and transmit the audio output.

Therefore there is a need in the art for a combination cooler and audio console that allows a digital music player to be communicably connected to a soft or hard-sided cooler and includes speakers for transmitting the audio feed from the digital audio player. Furthermore, there is a need in the art for a combination cooler and digital audio music console in which the music console is capable of being adjusted to several different angles to better direct the audio feed in the direction of the listening audience. In addition, there is a need in the art for a digital audio console that includes speakers and a digital audio player attachment and is capable of being removed from the cooler and moved to a location that is preferred by the listening audience.

### SUMMARY OF THE INVENTION

A cooler and digital audio console combines the entertainment of a digital audio player with the convenience of a cooler is one portable container. Digital audio players have revolutionized the music industry. Generally smaller than a traditional radio, cassette player, or compact disc player, the digital audio players are capable of storing a significant number of audio files in a assortment and order that is desired by the user and in a more compact and portable device than prior playing platforms. Digital audio players include MP3 players, MP4 players, personal game players, personal (or portable) video players, and the like. In certain embodiments, the digital audio player can provide video as well as audio content. For one aspect of the present invention, a cooler and digital audio console can include an insulated container having a base, one or more wall panels coupled to the base, and a lid. The cooler lid can be removable from or rotatably coupled to one or more of the wall panels. The cooler lid can include a removable and adjustable audio player housing.

The audio player housing can include one or more speakers, and amplifier, and an integration device for connecting a digital audio player to the electronic components of the audio player housing. The audio player housing can also include a control panel for providing power and control features for the audio feed being emitted by the digital audio player. The audio player housing can further include an headphone jack for providing another connecting method to the digital audio player. The digital audio player can connect to the audio player housing by inserting the headphone jack into the headphone receiver jack on the digital audio player. The audio player housing can further include a support stand that assists the audio player housing to be adjusted to different angles to direct the speakers towards the listening audience thereby enhancing the sound quality. In addition, the audio player housing can be removed from the lid or cooler body and relocated to an area more convenient to the listening audience.

For another aspect of the present invention, the portable cooler and audio player can include an insulated container having an outer shell and an inner shell. The inner shell is typically spaced inward from the outer shell creating an intermediate void between the inner and outer shell. Insulation can be placed within the intermediate void. The cooler can also include a lid that is rotatably coupled to or removable from insulated container. An audio player can be attached to one of the walls of the outer shell. The audio player can include an integration device, an amplifier, a control panel, and a plurality of speakers electronically coupled together. The integration device can connect a digital audio player to the electronic components of the audio player and can include a docking port. The audio player can further include a headphone jack for providing another connecting method to the digital audio player. The digital audio player can connect to the audio player housing by inserting the headphone jack into the headphone receiver jack on the digital audio player. The cooler can also include wheels and an adjustable telescoping handle to improve the portability of the cooler.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 illustrates a top perspective view of a combination cooler and digital audio player according to one exemplary embodiment of the present invention;

FIG. 1A illustrates an top and side perspective view of the combination cooler and digital audio player according to the exemplary embodiment of FIG. 1; and

FIGS. 2 and 2A illustrate a detailed and side view of the digital audio console housing of the combination cooler and digital audio player according to the exemplary embodiment of FIG. 1;

FIG. 3 illustrates a detailed view of the electrical connection between a digital audio player and a digital audio console housing according to the exemplary embodiment of FIG. 1;

FIGS. 4A-C illustrate perspective views of the adjustability and maneuverability of the digital audio console housing according to the exemplary embodiment of FIG. 1;

FIG. 5 illustrates a perspective view of the digital audio console housing positioned in a horizontal manner within the cooler lid in accordance with the exemplary embodiment of FIG. 1;

FIG. 6 illustrates a perspective view of the digital audio console housing positioned at an angle along the cooler lid in accordance with the exemplary embodiment of FIG. 1;

FIG. 7 illustrates a perspective view of a cooler and digital audio player in accordance with the exemplary embodiment of FIG. 1; and

FIG. 8 illustrates a perspective view of an alternative embodiment for a cooler and digital audio player in accordance with another exemplary embodiment of the present invention.

### DETAILED DESCRIPTION OF THE EXEMPLARY EMBODIMENTS

Exemplary embodiments of the invention will now be described in detail with reference to the included figures. The exemplary embodiments are described in reference to how they might be implemented. In the interest of clarity, not all features of an actual implementation are described in this specification. Those of ordinary skill in the art will appreciate that, in the development of an actual embodiment, several implementation-specific decisions must be made to achieve the inventors' specific goals, such as compliance with system-related and business-related constraints that can vary from one implementation to another. Moreover, it will be appreciated that such a development effort might be complex and time-consuming, but would nevertheless be a routine undertaking for those of ordinary skill in the art having benefit of this disclosure. Further aspects and advantages of the various figures of the invention will become apparent from consideration of the following description and review of the figures.

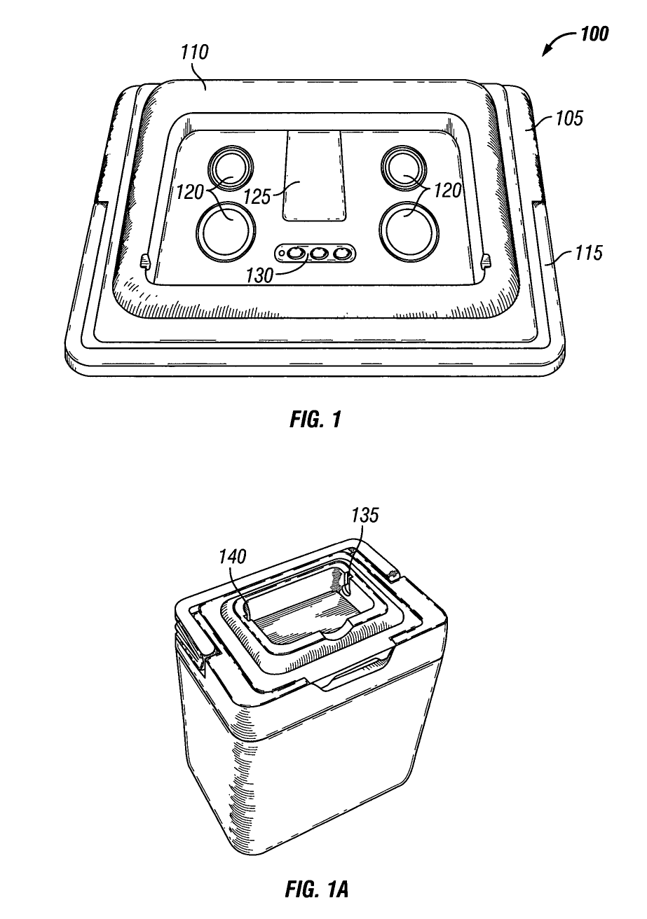

Referring now to FIG. 1, a perspective view of a combination cooler and digital audio console apparatus 100 (hereinafter “apparatus”) according to an exemplary embodiment of the present invention is described. The exemplary apparatus 100 can include a cooler body 105, a lid 110, and a handle 115. The cooler body 105 can be soft-sided hard-sided, or a combination thereof and can have a number of shapes and capacities. In one exemplary embodiment, the cooler body 105 has a substantially rectangular shape, however, those of ordinary skill in the art will recognize that other shapes can be used without departing from the novel aspects of this invention. The cooler body 105 includes an interior shell (Not Shown) surrounded by insulation, and further surrounded by an exterior material or shell. In certain exemplary embodiments, polyurethane foam insulation is used, however, those of ordinary skill in the art will recognize that many other forms of insulating material may be used, including polystyrene, air, etc. In certain exemplary embodiments, the exterior of the cooler body 105 is made of a hardened material, such as acrylonitrile butadiene polystyrene (“ABS”) plastic.

The lid 110 can be attached to the cooler body 105 by known attachment means. In embodiments where the lid 110 is attached to the cooler body 105, the lid 110 is capable of rotational movement to allow access to the interior portion of the cooler body 105. In other exemplary embodiments, the lid 110 is not permanently affixed to the cooler body 105, but instead, can be slidably removed and applied onto or into the cooler body 105. The lid 110 can be soft-sided, hard-sided, or a combination thereof and can have a number of shapes. The lid 110 also includes a audio module cavity 145 positioned along the top side of the lid 110. The audio module cavity 145 is essentially a void or cut-out area in the top of the lid 110. In one exemplary embodiment, the audio module cavity 145 has a substantially rectangular shape; however, those of ordinary skill in the art will recognize that the shape is not critical to the operation of the apparatus and thus, many other shapes and sizes of cavity may be created. In an alternative embodiment, the audio module cavity 145 can be positioned along and into one of the sides or bottom of the cooler body 105.

The audio module cavity 145 includes one or more audio module sockets 135, 140. Each audio module socket 135, 140 is capable of acting as a receptor for a pin or rod that can rotate within the audio module socket 135, 140. The lid 110 may be made from a solid piece of material, or insulation can be inserted between a top and bottom side of the lid 110. In addition, the lid 110 made of hard-sided materials can be manufactured to be attached or slidably attached to a cooler body 105 made of soft-sided materials. In one exemplary embodiment, the lid 110 is made from ABS plastic; however, other soft-sided and hard-sided materials known to those of ordinary skill in the art may be used.

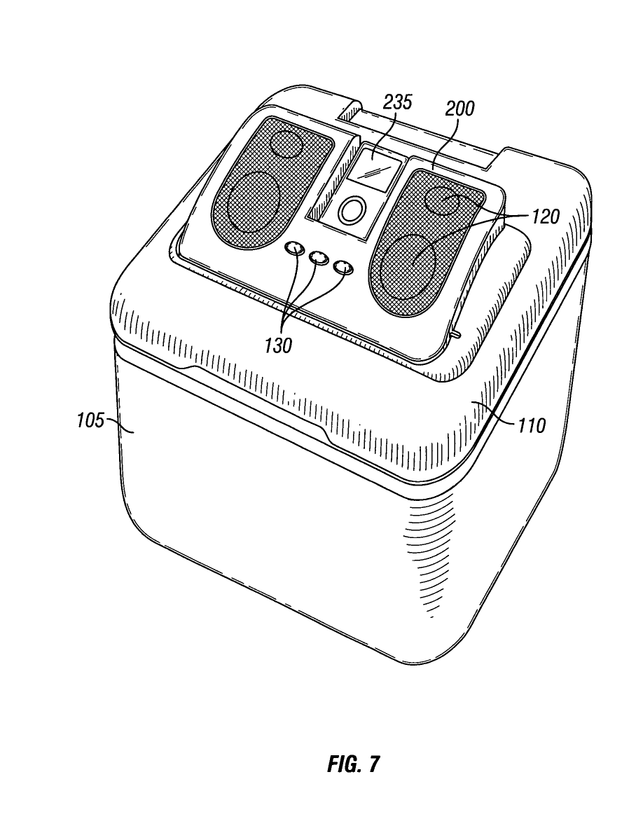

The lid 110 also includes a digital audio console housing 200 (see FIG. 7). The console housing 200 can be affixed to or slidably inserted into audio module cavity 145 in the lid 110. In one exemplary embodiment, as shown in FIG. 1A, the console housing 200 can be slidably inserted into the music module cavity 145 through the use of the audio module sockets 145. The console housing 200 may be made from a solid piece of material, multiple pieces of material, or insulation can be inserted between the top and bottom sides of the console insert 200. In addition, the console housing 200 may be manufactured in such a way as to make it waterproof or water-resistant. In one exemplary embodiment, the music console insert 200 is made from ABS plastic; however, other soft-sided, flexible, or hard-sided materials known to those of ordinary skill in the art may be used.

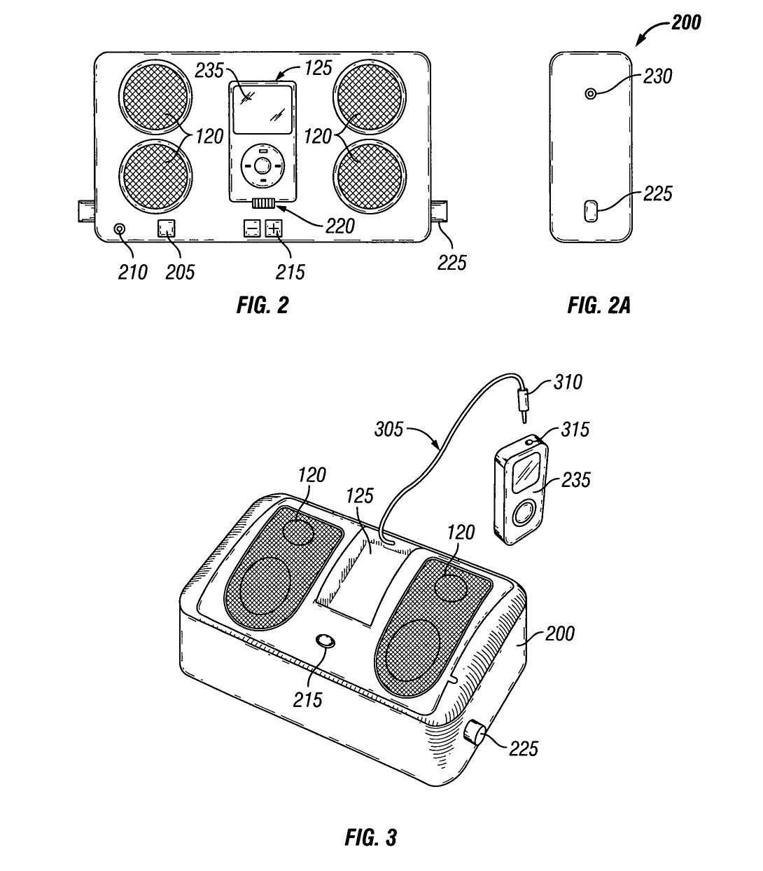

Referring now to FIGS. 1, 2, and 2A, the console housing 200 includes one or more speakers 120 positioned along the top portion of one side of the console housing 200 and attached thereto by known attachment means. In another exemplary embodiment, the speakers 120 may be positioned along one or more sides of the cooler body 105 or the lid 110, irrespective of whether speakers 120 are positioned on the console housing 200. The speakers 120 output the audio feed provided by the digital audio player 235. In one exemplary embodiment, four speakers 120 are positioned along the top of the console housing 200. The console housing 200 also includes a digital audio player cavity 125 positioned along the one side of the console insert 200. The digital audio player cavity 125 can be sized to receive multiple different types of digital audio player 235 such that, when inserted into the digital audio player cavity 125, the face of the digital audio player 235 is at a level substantially equal to the top level of the console insert 200. In an alternative embodiment, the digital audio player cavity 125 can include straps or keepers (Not Shown) designed to hold the digital audio player 235 in place in the cavity 125. The straps may be pliable or non-pliable and may include Velcro to allow for adjustability with various digital audio player sizes and shapes. While FIG. 2 shows the digital audio player 235 included with the music console insert 200, it should be understood that the digital audio player 235 may or may not be provided with the cooler 100. Digital audio players include MP3 players, MP4 players, personal game players, personal (or portable) video players, and the like. In certain exemplary embodiments, the digital audio player 235 can provide video as well as audio content.

The digital audio player cavity 125 also includes an integration device (Not Shown) electronically coupled to an amplifier (if included), the control panel 130 and/or the speakers 120. The integration device provides a connection mechanism to the digital audio player 235. In one exemplary embodiment, the integration device is a docking port capable of being slidably inserted into or onto a port receptacle of the digital audio player 235. However, other connection methods known to those of ordinary skill in the art may be used.

The console housing 200 also includes a control panel 130 positioned adjacent to the digital audio player cavity 125 on one side of the consol housing 200. As shown in FIG. 2, the control panel 130 can include a power switch 205 for turning the audio console on and off. In certain exemplary embodiments, the power switch 205 is attached to the top of the console housing 200 by known attachment means and is electrically coupled to the speakers 120, and/or amplifier (if included). In one exemplary embodiment, the power switch 205 is a touch sensitive pad. The control panel 130 can further include a power indicator 210. In certain exemplary embodiments, the power indicator 210 is attached to one side of the console housing 200 by known attachment means. In these exemplary embodiments, the power indicator 210 is a light emitting diode (“LED”); however, many other types of power indicators known to those of ordinary skill in the art can be used.

The control panel 130 can further include volume control 215. The volume control 215 is attached to the console housing 200 by known attachment means and is electronically coupled to the speakers 120, amplifier (if included) and/or the digital audio player 235. The volume control 215 is capable of raising and lowering the decibel level of the audio feed being played by the speakers 120. In certain exemplary embodiments, the volume control 215 includes two or more touch sensitive pads positioned adjacent to the digital audio player 235, however, the position of the volume control 215 on other areas of the lid or cooler body 105 are contemplated by this invention. Those of ordinary skill in the art will recognize that other types of controls including, but not limited to, bass level, treble level, balance, fast forward, reverse, next track, previous track, skip, etc., can be incorporated into the control panel 130 and are considered within the scope of this invention. In addition, the console housing 200 can include an amplifier (Not Shown), a digital or analog am/fm tuner (Not Shown), knobs or buttons capable of adjusting between the radio and digital music player 235 and for adjusting the tuner, and/or an antenna for receiving radio frequencies.

The audio console housing 200 can further include one or more pivot pins 225 positioned along the sides of the console housing 200. The pivot pins 225 may be molded from the same material and integral with the console housing 200 in a single molding operation. Alternatively the pivot pins 225 may be made of a metallic or hard plastic material and attached to the console housing 200 by known attachment means. As described above, the pivot pins 225 are capable of being slidably inserted into the audio module sockets 135, 140 so that the angle of the console housing 200 may be rotationally adjusted about the axis of the pivot pin(s) 225. In certain exemplary embodiments, each pivot pin 225 has a shape that is not completely round, but instead, includes flats on both sides so that when the console housing 200 is at a position of 90 degrees from horizontal, the music console housing 200 can be removed from the audio module cavity 145 in the lid 110 with very limited interference or drag from the audio module cavity 145.

In one exemplary embodiment, as shown in FIGS. 4A-C the console housing 200 can be positioned at an angle so that the audio feed output by the speakers 120 has a higher likelihood of being directed at or near the listening audience. Turning now to FIGS. 4A-C, the audio console housing 200 can also include a member 405 on one side of the audio console housing 200. The member 405 allows the audio console housing 200 to be attached or detached from the cavity 145 with the application of pressure. In certain exemplary embodiments, the application of pressure may occur at one or more lifting areas 425 to remove the audio console 200 for rotation within the cavity 145. In certain exemplary embodiments, the lifting areas 425 are cut-outs along the bottom portion of the audio console housing 200 and are of a size and shape sufficient to allow a person to place one or more fingers into the cut-out 425 and apply an outward force away from the cavity 145 to rotate the audio console housing 200 about the pins 225.

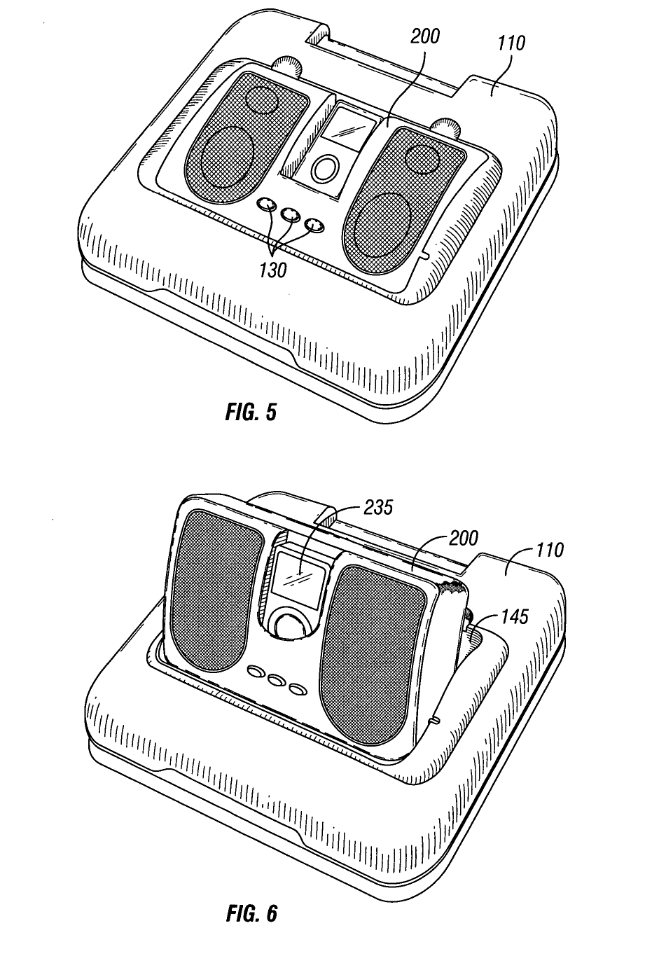

FIGS. 5 and 6 are exemplary embodiments of the adjustability of the audio console housing 200. FIG. 5 provides a perspective view of the lid 110 of the cooler 110 with the audio console housing 200 in a horizontal, or flat position according to certain exemplary embodiments of the present invention. FIG. 6 provides a perspective view of the lid 110 with the audio console housing 200 in a raised position according to certain exemplary embodiments of the present invention. The audio console housing 200 also includes a foot support, or stand, member 410. In certain exemplary embodiments, the foot support member 410 can rotate about an axis along the sides, top or bottom of the audio console housing 200. As shown in FIGS. 4A and 4C, a portion of the foot support member 410 can rotate out from the audio console housing 200 and rest along the lid 110 or cavity 145, or in certain embodiments along a flat surface separate from the cooler 100, and provide support for the audio console housing 200 to stand in a position other than the horizontal position. In certain exemplary embodiments, the foot support member 410 can include a spring 415, as shown in FIG. 4C or other device that provides a substantially constant force that causes one end of the foot support member 410 to extend away from the music console 200. Those of ordinary skill in the art will recognize that the spring 415 could, in the alternative, be designed to provide a force that causes the foot support member 410 to return to a resting position up against the audio console housing 200.

The console housing 200 may be held at different angles by friction or by the foot support member 410 or other device known to those of ordinary skill in the art, positioned on the underside of the console housing 200. In alternative embodiments, the foot support member 410 or its equivalent could be positioned along the top of the lid 110, top of the audio console housing 200, or side of the cooler 105. In another exemplary embodiment, the console housing 200 can be removed from the lid 110 and moved to a more desirable location away from the cooler 100 where the console housing 200 can continue to transmit the audio feed to the listening audience. The audio console housing 200 can also include a power source 420. In one exemplary embodiment, the power source is positioned along the back side of the music console 200, however those of ordinary skill in the art will recognize that the power source could be positioned along any side or the top of the audio console housing 200, the lid 110 or the cooler body 105. In this exemplary embodiment, the power source is a battery compartment capable of receiving conventional battery products for powering the audio console hosing 200. In an alternative embodiment, the power source is a rechargeable power source.

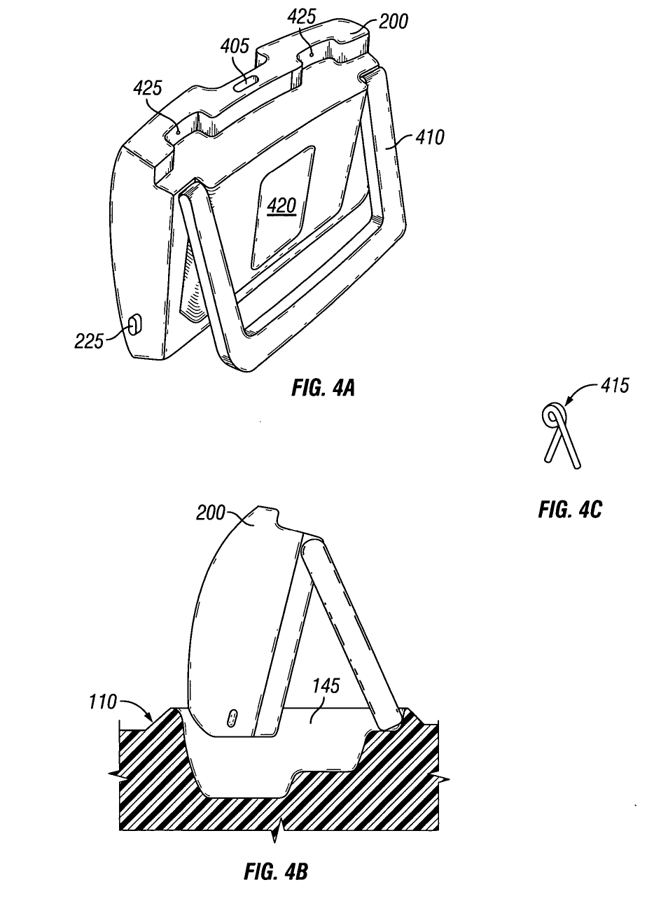

Turning now to FIG. 3, the audio console housing 200 further includes an audio cable 305 and headphone jack 310. The audio cable 305 is communicably connected to the speakers 120, amplifier, and/or control panel 130. The headphone jack 310 communicably connects the digital audio player 235 to the speakers 120 through the audio cable 305, amplifier, and/or control panel 130. In certain exemplary embodiments, the headphone jack 310 is capable of being connected to the jack receptacle 315 of multiple types and brands of digital audio players 235. In certain exemplary embodiment, the headphone jack 310 is a 3.5 millimeter stereo plug.

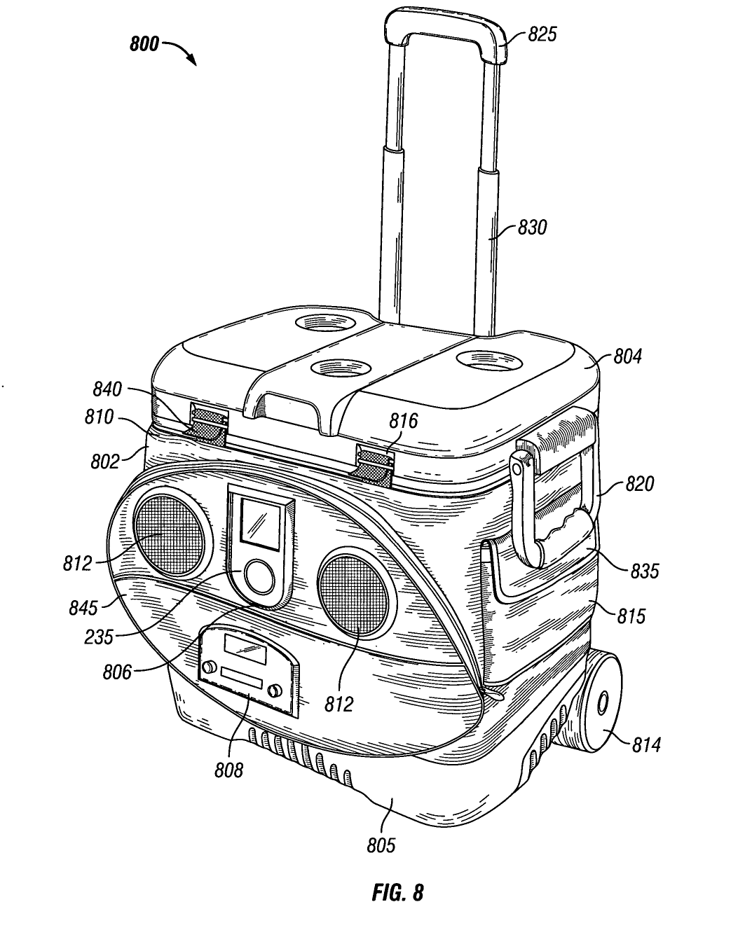

FIG. 8 illustrates a perspective view of an alternative embodiment for a cooler and digital audio player in accordance with another exemplary embodiment of the present invention. Referring now to FIG. 8, the alternative cooler and digital music console apparatus 800 can include a base 805, a cooler body 802, a lid 804, one or more wheels 814, a telescoping pull handle 825, and one or more handles 820 positioned along the sides of the cooler body 802. The cooler body 802 can be soft-sided, hard-sided, or a combination thereof and can have a number of shapes and capacities. In certain exemplary embodiments, the cooler body 802 has a substantially rectangular shape; however, those of ordinary skill in the art will recognize that other shapes can be used without departing from the novel aspects of this invention.

The cooler body 802 includes an interior shell (Not Shown) surrounded by insulation, and further surrounded by an exterior shell 810. In certain exemplary embodiments, the interior shell of the cooler body 802 is made of a hardened material, such as plastic. Furthermore, in certain exemplary embodiments, the exterior shell 810 of the cooler body 802 is made of a pliable material, such as nylon fabric. In yet other exemplary embodiments, the exterior shell 810 can include a combination of hard material, such as plastic, and a pliable material, such as nylon fabric. The hard material can be ABS plastic. In certain exemplary embodiments, polyurethane foam insulation is used in the intermediate void between the interior and exterior shells; however, those of ordinary skill in the art will recognize that many other forms of insulating material may be used, including polystyrene, air, etc. The cooler body 802 is positioned substantially above and attached to the base 805 by known attachment means. The base 805 can be soft or hard-sided and can have a number of shapes, including, in certain exemplary embodiments, a substantially rectangular shape. In one exemplary embodiment, the base 805 is made of polyvinyl chloride (“PVC”).

The lid 804 is attached to the cooler body 802 by known attachment means, such as hinges (Not Shown), and is capable of rotational movement about the attachment means to allow access to the interior portion of the cooler body 802. In another exemplary embodiment, the lid 804 is not permanently affixed to the cooler body 802, but instead, can be slidably removed and applied onto or into the cooler body 802. In this embodiment, the lid 804 typically has an interference or snap-in fit with the cooler body 802. The lid 804 can be made of a hard material, a soft material, such as nylon fabric, or a combination thereof and can have a number of shapes.

The cooler 800 also includes one or more wheels 814. The wheels 814 can be made of plastic, rubber or other materials known to those of ordinary skill in the art. The wheels 814 can be positioned adjacent to the base 805 along the corners of the cooler body, as shown in FIG. 8. Each wheel 814 is capable of rotating about an axis to assist in rolling the cooler 800 along hard or semi-hard surfaces. In one exemplary embodiment, one wheel 814 is positioned along each of two adjacent corners near the base 805 of the cooler 800; however, additional wheels 814, wheels positioned along additional areas of the cooler 800 or a combination thereof are also contemplated within this invention. For example, four wheels 814 could be positioned under the base 805 of the cooler 800 or could be positioned at each corner adjacent to the base 805.

The cooler 800 also includes a telescoping pull handle 825, shown fully extended in FIG. 8, coupled to the cooler 800. The telescoping pull handle 825 includes a handle grip and one or more telescoping members 830 that are coupled to the handle grip. In certain exemplary embodiments, the telescoping pull handle 825 includes two telescoping members 830, with each telescoping member 830 coupled to one of two ends of a pull handle, as shown in FIG. 8. The telescoping pull handle 825 can further include a locking mechanism (Not Shown) for locking the handle 825 in the extended and/or retracted position. The telescoping pull handle 825 is typically coupled to one side of the cooler body 802, however, the handle 825 could also be coupled to the base 805 and/or the lid 804 of the cooler 800.

The cooler body 802 also includes an audio player compartment 845 positioned along the one of the walls of the outer shell 810 of the cooler body 802. In an alternative embodiment, the audio player compartment 845 can be positioned along the lid 804 of the cooler body 105. The audio player compartment 845 may be manufactured in such a way as to make it waterproof or water-resistant. In one exemplary embodiment, the audio player compartment 845 is made from nylon fabric, however, other soft-sided, flexible, or hard-sided materials known to those of ordinary skill in the art may be used.

The audio player compartment 845 includes one or more speakers 812 in a spaced-apart orientation and positioned along one of the sides of the outer shell 810 of the cooler body 802 and attached thereto by known attachment means. In another exemplary embodiment, the speakers 812 may be positioned along multiple sides of the cooler body 802 or the lid 804. The speakers 812 output the audio feed provided by the digital audio player 235. In certain exemplary embodiments, two speakers 812 are positioned along one side of the cooler body 802. The audio player compartment 845 also includes a digital audio player holder 806 positioned along one side of the cooler body 802. The digital audio player holder 806 can be sized to receive multiple different types of digital audio player 235 such that, when inserted into the digital audio player holder 806, the face of the digital audio player 235 is facing away from the inner shell of the cooler body 802.

In an alternative embodiment, the digital audio player holder 806 can include straps or keepers (Not Shown) designed to hold the digital audio player 235 substantially in place in the holder 806. The straps may be pliable or non-pliable and may include Velcro to allow for adjustability with various digital audio player sizes and shapes. The digital audio player holder 806 can also include a transparent material, such as transparent plastic, along the exterior of the holder 806, so that the digital audio player 235 positioned within the holder 806 may be viewed without having to remove the digital audio player 235 from the holder 806. The digital audio player holder 806 can further include an integration device (Not Shown) electronically coupled to the amplifier, the control panel 808 and/or the speakers 812. The integration device provides a connection mechanism to the digital audio player 235. In one exemplary embodiment, the integration device is a docking port capable of being slidably inserted into or onto a port receptacle of the digital audio player 235. However, other connection methods known to those of ordinary skill in the art may be used. The digital audio player 235 can be, but is not limited to, an MP3 player, an MP4 player, a personal (or portable) video player and a portable game player, each of which may be capable of providing video as well as audio content. The digital audio player 235 may or may not be provided with the cooler 800.

The audio player compartment 845 also includes an amplifier (Not Shown) electronically coupled using known methods to the speakers 812 the control panel 808, and the integration device. The audio player compartment 845 also includes a control panel 808 positioned adjacent to the digital audio player holder 806. The control panel 808 is electronically coupled to the amplifier, integration device and the speakers 812. The control panel 808 can include a power switch for turning the power to the audio player compartment 845 or one or more of its components on and off. In certain exemplary embodiments, the power switch is a touch sensitive pad. The control panel 808 can also include a power indicator. In one exemplary embodiment, the power indicator is a light emitting diode (“LED”), however, many other types of power indicators known to those of ordinary skill in the art can be used.

The control panel 808 can further include volume control. The volume control can be electronically coupled to the amplifier, speakers 812 and the digital audio player 235. The volume control is capable of raising and lowering the decibel level of the audio feed being played by the speakers 812. In one exemplary embodiment, the volume control includes two or more touch sensitive pads positioned adjacent to the digital audio player 235, however, other known types of volume control are contemplated by this invention. Those of ordinary skill in the art will recognize that other types of controls including, but not limited to, bass level, treble level, balance, fast forward, rewind, skip track, next track and previous track can be incorporated into the control panel 808 and are considered within scope of this invention. In addition, in an alternative embodiment, the control panel 808 can include a digital or analog am/fm tuner (Not Shown), knobs or buttons capable of adjusting between the radio and digital music player 235 and for adjusting the tuner, and an antenna for receiving radio frequencies.

The audio player compartment 845 can also include a power source (Not Shown). In one exemplary embodiment, the power source is positioned along the back side of the audio player compartment 845 however those of ordinary skill in the art will recognize that the power source could be positioned along any side of the cooler body 802, the base 805, or the lid 804 of the cooler 800. In certain exemplary embodiments, the power source is a battery compartment capable of receiving conventional battery products for powering the audio player compartment 845. In an alternative embodiment, the power source is a rechargeable power source. In yet another alternative embodiment, the power needs of the components in the audio player compartment 845 are satisfied by the power source of the digital audio player 235.

The audio player compartment 845 can also include an audio cable and headphone jack (Not Shown). The audio cable is electronically connected to the amplifier and/or control panel 808. The headphone jack can communicably connect the digital audio player 235 to the amplifier, speakers 812, and control panel 808 through the audio cable. In one exemplary embodiment, the headphone jack is capable of being connected to the headphone jack receptacle of multiple types and brands of digital audio players 235. In one exemplary embodiment, the headphone jack is a 3.5 millimeter stereo plug.

The cooler 800 can further include one or more strap receptacles 816. The strap receptacles 816 are generally positioned adjacent the top rim of the outer shell 810 of the cooler body 802. The strap receptacles 816 can include a recess or channel in the outer shell 810 for receiving one or more straps 840. Alternatively, the strap receptacles 816 can be positioned along the perimeter of the lid 804. The straps 840 are coupled along one end to the audio player compartment 845 and are removably coupled along the other end to one of the strap receptacles 816. The straps 840 can be made of a pliable or non-pliable material and provide additional support for the audio player compartment 845.

The cooler body 802 can also include one or more pockets, or storage compartments, 815 positioned along one or more sides of the cooler 800. The pockets 815 allow objects to be slidably inserted into the top side thereof. The pockets 815 typically extend upward from an area adjacent to the base 805 and may be made of several different types of material. In certain exemplary embodiments the pockets 815 on the sides of the cooler 800 are slip pockets made of a nylon material. In additional exemplary embodiments, the pockets 815 can be constructed of an expandable mesh material. Each pocket 815 typically includes a flap 835 that is coupled on one end to the one of the sides of the cooler 800 and has another end that extends over the opening in the pocket 815. Each flap 835 and a portion of the exterior of the corresponding pocket 815 can include closures, such as Velcro, snaps, zippers or other closures known to those of ordinary skill in the art for coupling and de-coupling the pocket 815 from the flap 835. In an alternative embodiment, the closure can be provided between the pocket 815 and the cooler body 802, thereby allowing the open end of the pocket 815 to be removably coupled to the outer shell 810 of the cooler body 802 and eliminating the need for the flap 835. The cooler body 802 can also include a pass-through pocket (Not Shown) on one or more sides of the cooler body 802. A pass-through pocket provides access to its contents from two different sides of the pocket. A pass-through pocket can include a first closure and a second closure. Each closure can provide access to the interior of the pass-through pocket.

While the invention is susceptible to various modifications and alternative embodiments, exemplary embodiments have been shown by way of example in the figures and have been described herein. However, it should be understood that the invention is not intended to be limited to the exemplary embodiments disclosed. Rather, the intention is to cover all modifications, equivalents, and alternatives falling within the spirit and scope of the invention as described.

I claim:

1. A portable cooler and audio player for carrying food and/or beverages comprising:
an insulated container comprising:
at least one enclosure wall panel;
an enclosure base coupled to the enclosure wall panel; and
a lid; and
an audio player positioned along the insulated container and comprising:
an integration device, wherein the integration device integrates a portable audio/video device with the audio player; and
at least one speaker electronically coupled to the integration device.

2. The apparatus of claim 1, further comprising a control panel electronically coupled to the integration device, wherein the control panel is positioned adjacent the integration device on the insulated container.

3. The apparatus of claim 2, wherein the control panel comprises a touch pad.

4. The apparatus of claim 2, wherein the control panel comprises volume control.

5. The apparatus of claim 1, wherein the integration device comprises a docking station.

6. The apparatus of claim 1, wherein the integration device comprises a docking connector.

7. The cooler of claim 1, wherein the integration device comprises a headphone jack.

8. The cooler of claim 1, wherein the insulated container comprises four enclosure wall panels.

9. The cooler of claim 1, further comprising a portable power source electronically coupled to the audio player.

10. The cooler of claim 1, further comprising:
a recessed cavity in the insulated container; and
a housing encapsulating the audio player, wherein the housing comprises an outer peripheral rim for engaging and fitting within the recessed cavity.

11. The cooler of claim 10, wherein the housing further comprises an adjustable stand, wherein the stand rotates about an axis from a first position to a second position, wherein when the stand is in the first position the stand does not provide support for the housing and when the stand is in the second position the stand provides support for the housing to stand without assistance from the insulated container.

12. The cooler of claim 10, further comprising a pivot pin coupled the rim of the housing, wherein the pivot pin allows a portion of the housing to be rotatably adjusted out from the recessed cavity about an axis of the pivot pin.

13. The cooler of claim 10, wherein the recessed cavity is positioned within the lid.

14. The cooler of claim 10, wherein the recessed cavity is positioned within one of the enclosure wall panels.

15. The cooler of claim 1, wherein the audio player comprises a first speaker positioned adjacent one side of the integration device and a second speaker positioned adjacent an opposing side of the integration device.

16. A portable cooler and audio player comprising:
an insulated container comprising an outer shell and an inner shell, wherein the inner shell is spaced inward from and coupled to the outer shell forming an intermediate void, wherein each shell comprises:
four adjoining walls; and
a base coupled to each of the adjoining walls;
a layer of insulating material positioned within the intermediate void;
a lid;
a recessed cavity in the insulated container;
a housing capable of being slidably positioned within the recessed cavity, said housing comprising:
an outer peripheral rim, wherein at least a portion of the rim engages the recessed cavity; and
an audio player comprising:
an integration device, wherein the integration device integrates a portable audio/video device with the audio player;
a control panel; and
a plurality of speakers electronically coupled to the integration device and the control panel.

17. The cooler of claim 16, wherein the integration device comprises a docking connector for electronically coupling to the audio/video device.

18. The cooler of claim 16, wherein the integration device comprises a headphone jack for electronically coupling to the audio/video device.

19. The cooler of claim 16, wherein the control panel comprises:
at least one device for controlling the volume output by the speakers; and
at least one device for turning the power to the speakers on and off.

20. The cooler of claim 16, further comprising:
a plurality of wheels coupled to the outer shell and positioned adjacent the base of the cooler; and
at least one handle coupled to the outer shell.

21. The cooler of claim 20, wherein the handle is positioned along one of the side walls of the outer shell and wherein the handle is telescopically adjustable from a first position to a second position.

22. The cooler of claim 16, wherein the recessed cavity is positioned within the lid.

23. The cooler of claim 16, wherein the recessed cavity is positioned within one of the walls of the insulated container.

24. A portable cooler and audio player comprising:
an insulated container comprising an outer shell and an inner shell, wherein the inner shell is spaced inward from and coupled to the outer shell forming an intermediate void, wherein each shell comprises:
four adjoining walls; and
a base coupled to each of the adjoining walls;
a layer of insulating material positioned within the intermediate void;
a lid;
an audio player coupled to one of the walls of the outer shell, said audio player comprising:
an integration device, wherein the integration device integrates a portable audio/video device with the audio player;
an amplifier electronically coupled to the integration device
a control panel electronically coupled to the amplifier; and
a plurality of speakers electronically coupled to the amplifier and the control panel.

25. The cooler of claim 24, wherein the outer shell comprises nylon fabric and the inner shell comprises a hard plastic.

26. The cooler of claim 25, further comprising a plurality of pockets coupled to the outer shell and positioned about the walls of the outer shell.

27. The cooler of claim 24, wherein both the outer and inner shells comprise hard plastic.

28. The cooler of claim 24, further comprising:
a plurality of wheels coupled to the outer shell and positioned adjacent the base of the cooler; and
at least one handle coupled to the cooler, wherein the handle comprises at least one telescoping arm for adjusting the handle from a first position adjacent at least one of the sides of the cooler to a second position wherein the telescoping arm is extended.

29. The cooler of claim 24, wherein the integration device comprises a docking connector for electronically coupling to the audio/video device to the integration device.

30. The cooler of claim 24, wherein the integration device comprises a headphone jack for electronically coupling to the audio/video device to the integration device.

31. The cooler of claim 24, wherein the control panel comprises:
at least one device for controlling the volume output by the speakers; and
at least one device for turning the power for the audio player on and off.

32. The cooler of claim 24, wherein the audio player further comprises a portable power source electronically coupled to the amplifier, the control panel and the speakers.
